(19) United States
(12) Patent Application Publication
(10) Pub. No.: US 2019/0131039 A1
(43) Pub. Date: May 2, 2019

(54) POSITIVE TEMPERATURE COEFFICIENT DEVICES WITH OXYGEN BARRIER PACKAGES

(71) Applicant: Littelfuse, Inc., Chicago, IL (US)

(72) Inventors: Martin G. Pineda, Fremont, CA (US); Kedar Bhatawadekar, Santa Clara, CA (US); Dong Yu, Fremont, CA (US)

(73) Assignee: Littelfuse, Inc., Chicago, IL (US)

(21) Appl. No.: 15/801,689

(22) Filed: Nov. 2, 2017

(51) Int. Cl. H01C 17/00; H01C 7/02; H01C 7/13; H01C 1/14; H01C 17/28

(52) U.S. Cl. CPC H01C 17/00; H01C 7/02; H01C 17/28; H01C 1/1406; H01C 7/13

(57) ABSTRACT

A method of forming a positive temperature coefficient (PTC) device, the method including providing a core formed of a PTC material, the core having an electrode disposed on a first surface thereof and a second electrode disposed on a second surface thereof, connecting a first lead element to the first electrode, applying an oxygen barrier epoxy to at least portions of the core, the first electrode, the second electrode, and the first lead element, and curing the oxygen barrier epoxy to form an oxygen barrier package surrounding at least portions of the core, the first electrode, the second electrode, and the first lead element.

### FIELD OF THE DISCLOSURE

The present disclosure relates generally to the field of circuit protection devices, and relates more particularly to packaging for positive temperature coefficient devices.

### BACKGROUND OF THE DISCLOSURE

Positive temperature coefficient (PTC) devices are typically utilized in circuits to provide protection against overcurrent conditions. PTC material in the PTC device is selected to have a relatively low resistance within a normal operating temperature range of the PTC device, and a relatively higher resistance above the normal operating temperature range of the PTC device.

For example, a PTC device may be placed in series with a battery terminal so that all the current flowing through the battery flows through the PTC device. The temperature of the PTC device gradually increases as current flowing through the PTC device increases. When the temperature of the PTC device reaches an “activation temperature,” the resistance of the PTC device increases sharply. This in turn significantly reduces the current flow through the PTC device to thereby protect the battery from an overcurrent condition. When the overcurrent condition subsides, the temperature of the PTC device eventually falls below the activation temperature and the PTC device may once again become conductive as before the occurrence of the overcurrent condition.

A PTC device typically includes a core material (i.e., the PTC material) having PTC characteristics, as well as various electrically conductive layers, pads, and/or leads that may be coupled to surfaces of the PTC material to facilitate electrical connection of the PTC device to external circuit components. A PTC device typically also includes an electrically insulating “package” that surrounds some or all of the core material and the associated components for protecting such components from moisture, oxygen, and other corrosive agents that could otherwise degrade the performance of the PTC device over time.

PTC device packages are conventionally manufactured using panelization processes. These processes are typically time-consuming and costly, requiring numerous complicated manufacturing steps. Moreover, there are constraints on how small a PTC package can be made using panelization processes, thus limiting the size of the core material that can be implemented in a given form factor. Since the size of the core material dictates the capacity (i.e., the hold current) of a PTC device, the size of the package represents a major constraint on the capacity of a PTC device. This constraint is at odds with the increasing demand for PTC devices with improved capacity (i.e., higher hold currents) in smaller form factors.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A PTC device in accordance with an exemplary embodiment of the present disclosure may include a core formed of a PTC material, a first electrode disposed on a first surface of the core and a second electrode disposed on a second surface of the core, a first lead element connected to the first electrode, and an oxygen barrier package surrounding at least portions of the core, the first electrode, the second electrode, and the first lead element.

A method of forming a PTC device in accordance with an exemplary embodiment of the present disclosure may include providing a core formed of a PTC material, the core having an electrode disposed on a first surface thereof and a second electrode disposed on a second surface thereof, connecting a first lead element to the first electrode, applying an oxygen barrier epoxy to at least portions of the core, the first electrode, the second electrode, and the first lead element, and curing the oxygen barrier epoxy to form an oxygen barrier package surrounding at least portions of the core, the first electrode, the second electrode, and the first lead element.

### BRIEF DESCRIPTION OF THE DRAWINGS

FIG. 1 is a cross sectional view illustrating an exemplary embodiment of a PTC device in accordance with an embodiment of the present disclosure;

FIG. 2 is a cross sectional view illustrating another exemplary embodiment of a PTC device in accordance with an embodiment of the present disclosure;

FIG. 3 is a cross sectional view illustrating another exemplary embodiment of a PTC device in accordance with an embodiment of the present disclosure;

FIG. 4 is a cross sectional view illustrating another exemplary embodiment of a PTC device in accordance with an embodiment of the present disclosure;

FIG. 5 is a cross sectional view illustrating another exemplary embodiment of a PTC device in accordance with an embodiment of the present disclosure;

FIG. 6 is a flow diagram illustrating an exemplary method of manufacturing PTC devices in accordance with embodiments of the present disclosure.

### DETAILED DESCRIPTION

Embodiments of a positive temperature coefficient (PTC) device and methods for manufacturing the same in accordance with the present disclosure will now be described more fully with reference to the accompanying drawings, in which preferred embodiments of the present disclosure are presented. The PTC devices and the accompanying methods of the present disclosure may, however, be embodied in many different forms and should not be construed as being limited to the embodiments set forth herein. Rather, these embodiments are provided so that this disclosure will convey certain exemplary aspects of the PTC devices and the accompanying methods to those skilled in the art. In the drawings, like numbers refer to like elements throughout unless otherwise noted.

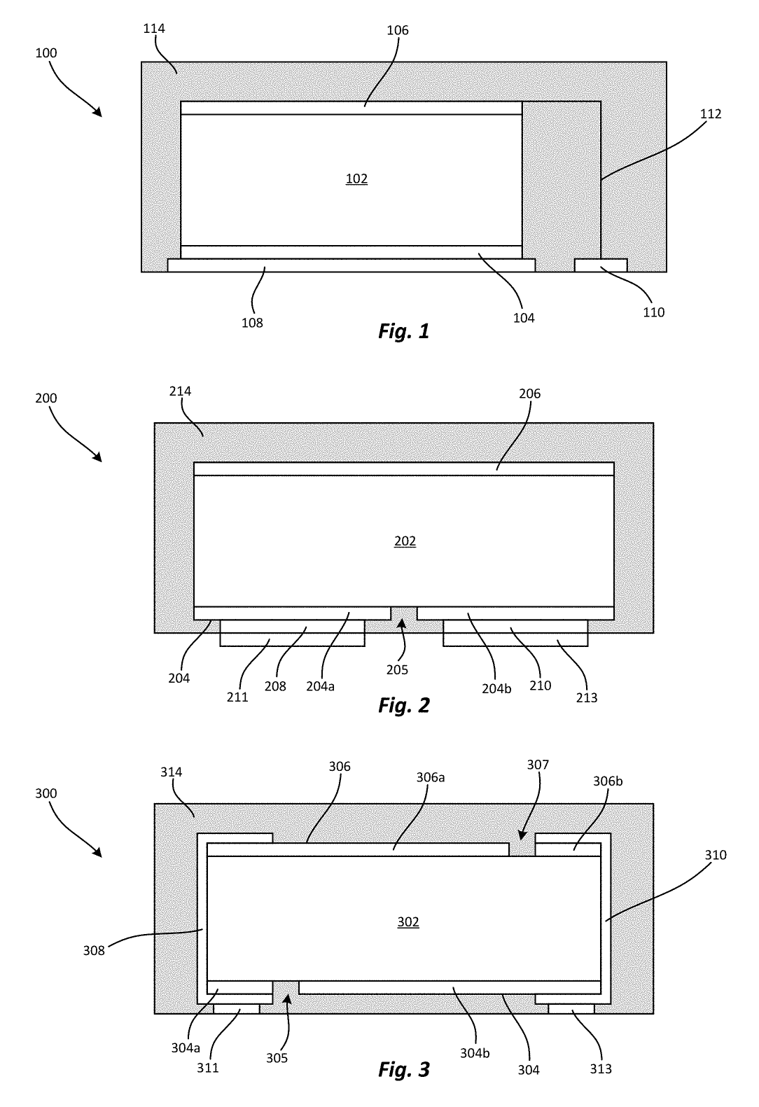

Referring to FIG. 1, a cross sectional view of a PTC device 100 in accordance with an exemplary embodiment of the present disclosure is illustrated. For the sake of convenience and clarity, terms such as “top,” “bottom,” “up,” “down,” “vertical,” and “horizontal” may be used herein to describe the relative positions and orientations of various components of the PTC device 100, all with respect to the geometry and orientation of the PTC device 100 as it appears in FIG. 1. Said terminology will include the words specifically mentioned, derivatives thereof, and words of similar import. Similar terminology will be used in a similar manner to describe subsequent embodiments disclosed herein.

The PTC device 100 may include a core 102 formed of a PTC material. Various examples of PTC materials and their characteristics will be familiar to those of ordinary skill in the art and will therefore not be described in detail herein. In a non-limiting embodiment, the core 102 may be formed of a polymeric positive temperature coefficient (PPTC) material. The core 102 may be provided with first and second electrodes 104, 106 (e.g., metallic foil) covering bottom and top surfaces thereof, respectively.

The PTC device 100 may further include electrically conductive first and second lead elements 108, 110 that are electrically connected to the bottom and top surfaces of the core 102 via the first and second electrodes 104, 106, respectively, for facilitating connection of the PTC device 100 within a circuit. The first lead element 108 may be substantially planar and may be disposed in flat and continuous contact with the first electrode 104. As depicted in FIG. 1, the first lead element 108 may be wider than the first electrode 104, but this is not critical. In various alternative embodiments, the first lead element 108 may be narrower than the first electrode 104. The first lead element 108 may be formed of any suitable, electrically conductive material, including, but not limited to copper, silver, nickel, etc.

The second lead element 110 may be substantially planar and may be disposed horizontally adjacent and spaced apart from the core 102 in a substantially coplanar relationship with the first lead element 108. The second lead element 110 may be electrically connected to the second electrode 106 by an interconnect 112. The interconnect 112 may be any suitable electrical conductor, including, but not limited to, a wire bond (or series of wire bonds), a ribbon, a clip, a wedge, etc. The second lead element 110 may be formed of any suitable, electrically conductive material, including, but not limited to copper, silver, nickel, etc. Thus, when the PTC device 100 is electrically connected within a circuit, electrical current flowing between the first lead element 108 and the second lead element 110 must flow through the core 102, thus enabling the overcurrent and overtemperature protection provided by the device 100.

The PTC device 100 may further include an electrically insulating, protective encapsulant or package 114 (hereinafter “the package 114”). The package 114 may be a contiguous, unitary coating that covers and encapsulates the other elements of the PTC device 100 in the manner shown in FIG. 1. Particularly, the package 114 may completely cover and encapsulate the core 102, the first and second electrodes 104, 106, the first and second lead elements 108, 110, and the interconnect 112 except for the bottom surfaces of the first and second lead elements 108, 110 which are left uncovered and exposed. The package may be formed of an oxygen barrier epoxy (hereinafter “the epoxy”), such as any commercial available epoxy or specially formulated epoxy that may be applied in a fluidic or semi-fluidic state (A-stage or B-stage) and subsequently cured into a hardened state (C-stage), as further described below, that provides an oxygen barrier and electrical insulation.

Thus, the package 114 of the PTC device 100, being formed of the above-described epoxy, may provide the device 100 with a robust, electrically insulating housing that may be implemented using inexpensive and expeditious manufacturing techniques, such as transfer molding and the like, as will be described in greater detail below. The oxygen barrier properties of the package 114 may provide the components of the PTC device 100 with improved protection against corrosion relative to conventional PTC device packages. Additionally, the package 114 may have a coefficient of thermal expansion (CTE) that is substantially similar to the CTE of the core 102 of the PTC device 100, and may thus accommodate thermal expansion and contraction of the core 102 without the risk of damage.

Referring to FIG. 2, a cross sectional view of a PTC device 200 in accordance with another exemplary embodiment of the present disclosure is illustrated. The PTC device 200 may include a core 202 formed of a PTC material. Various examples of PTC materials and their characteristics will be familiar to those of ordinary skill in the art and will therefore not be described in detail herein. In a non-limiting embodiment, the core 202 may be formed of a polymeric positive temperature coefficient (PPTC) material. The core 202 may be provided with first and second electrodes 204, 206 substantially covering bottom and top surfaces thereof, respectively. In some embodiments, the second electrode 206 may be omitted. The first electrode 204 may include a gap 205 formed therein to define horizontally adjacent first and second portions 204a, 204b that are electrically isolated from one another except via the core 202.

The PTC device 200 may further include electrically conductive first and second lead elements 208, 210 that are electrically connected to the bottom surface of the core 202 via the first and second portions 204a, 204b of the first electrode 204 for facilitating connection of the PTC device 200 within a circuit. The first lead element 208 may be substantially planar and may be disposed in flat and continuous contact with the first portion 204a, and the second lead element 210 may be substantially planar and may be disposed in flat and continuous contact with the second portion 204b. As depicted in FIG. 2, the first and second lead elements 208, 210 may be narrower than the first and second portions 204a, 204b, but this is not critical. In various alternative embodiments, one or both of the first lead element 208 and the second lead element 210 may be wider than the first and second portions 204a, 204b, respectively. The first and second lead elements 208, 210 may be formed of any suitable, electrically conductive material, including, but not limited to copper, silver, nickel, etc.

Each of the first and second lead elements 208, 210 may be coated with first and second solderable coatings 211, 213 that, during installation of the PTC device 200, may be heated and reflowed for establishing electrical connections between the first and second lead elements 208, 210 and other circuit elements, for example. The first and second solderable coatings 211, 213 may be formed of NiSn or NiAu, for example.

Thus, when the PTC device 200 is electrically connected within a circuit, electrical current flowing between the first lead element 208 and the second lead element 210 must flow through the core 202, thus enabling the overcurrent and overtemperature protection provided by the device 200.

The PTC device 200 may further include an electrically insulating, protective encapsulant or package 214 (hereinafter “the package 214”). The package 214 may be a contiguous, unitary coating that covers and encapsulates the other elements of the PTC device 200 in the manner shown in FIG. 2. Particularly, the package 214 may cover and encapsulate the core 202, the first and second electrodes 204, 206, and the first and second lead elements 208, 210, but not the first and second solderable coatings 211, 213 which are left uncovered and exposed.

The package 214 of the device 200 may be formed of the oxygen barrier epoxy described above in relation to the PTC device 100, and may similarly provide the PTC device 200 with a robust, electrically insulating package that may be implemented using inexpensive and expeditious manufacturing techniques, such as transfer molding and the like as will be described in greater detail below. The oxygen barrier properties of the package 214 may provide the components of the PTC device 200 with improved protection against corrosion relative to conventional PTC device packages. Additionally, the package 214 may have a coefficient of thermal expansion (CTE) that is substantially similar to the CTE of the core 202 of the PTC device 200, and may thus accommodate thermal expansion and contraction of the core 202 without the risk of damage.

Referring to FIG. 3, a cross sectional view of a PTC device 300 in accordance with another exemplary embodiment of the present disclosure is illustrated. The PTC device 300 may include a core 302 formed of a PTC material. Various examples of PTC materials and their characteristics will be familiar to those of ordinary skill in the art and will therefore not be described in detail herein. In a non-limiting embodiment, the core 302 may be formed of a polymeric positive temperature coefficient (PPTC) material. The core 302 may be provided with first and second electrodes 304, 306 substantially covering bottom and top surfaces thereof, respectively. The first electrode 304 may include a gap 305 formed therein to define horizontally adjacent first and second portions 304a, 304b that are electrically isolated from one another except via the core 302. Similarly, the second electrode 306 may include a gap 307 formed therein to define horizontally adjacent first and second portions 306a, 306b that are electrically isolated from one another except via the core 302.

The PTC device 300 may further include electrically conductive first and second lead elements 308, 310 formed of conductive epoxy. The first lead element 308 may cover a first horizontal end of the core 302 and may extend over the first portions 304a, 306a of the first and second electrodes 304, 306, respectively. The second lead element 310 may cover a second horizontal end of the core 302 opposite the first horizontal end and may extend over the second portions 304b, 306b of the first and second electrodes 304, 306, respectively.

Bottom portions of the first and second lead element 308, 310 may be covered with first and second solderable coatings 311, 313 that, during installation of the PTC device 300, may be heated and reflowed for establishing electrical connections between the first and second lead elements 308, 310 and other circuit elements, for example. The first and second solderable coatings 311, 313 may be formed of NiSn or NiAu, for example. Thus, when the PTC device 300 is electrically connected within a circuit, electrical current flowing between the first lead element 308 and the second lead element 310 must flow through the core 302, thus enabling the overcurrent and overtemperature protection provided by the device 300.

The PTC device 300 may further include an electrically insulating, protective encapsulant or package 314 (hereinafter “the package 314”). The package 314 may be a contiguous, unitary coating that covers and encapsulates the other elements of the PTC device 300 in the manner shown in FIG. 3. Particularly, the package 314 may cover and encapsulate the core 302, the first and second electrodes 304, 306, and the first and second lead elements 308, 310, but not the first and second solderable coatings 311, 313 which are left uncovered and exposed.

The package 314 of the device 300 may be formed of the oxygen barrier epoxy described above in relation to the PTC device 100, and may similarly provide the PTC device 300 with a robust, electrically insulating package that may be implemented using inexpensive and expeditious manufacturing techniques, such as transfer molding and the like, as will be described in greater detail below. The oxygen barrier properties of the package 314 may provide the components of the PTC device 300 with improved protection against corrosion relative to conventional PTC device packages. Additionally, the package 314 may have a coefficient of thermal expansion (CTE) that is substantially similar to the CTE of the core 302 of the PTC device 300, and may thus accommodate thermal expansion and contraction of the core 302 without the risk of damage.

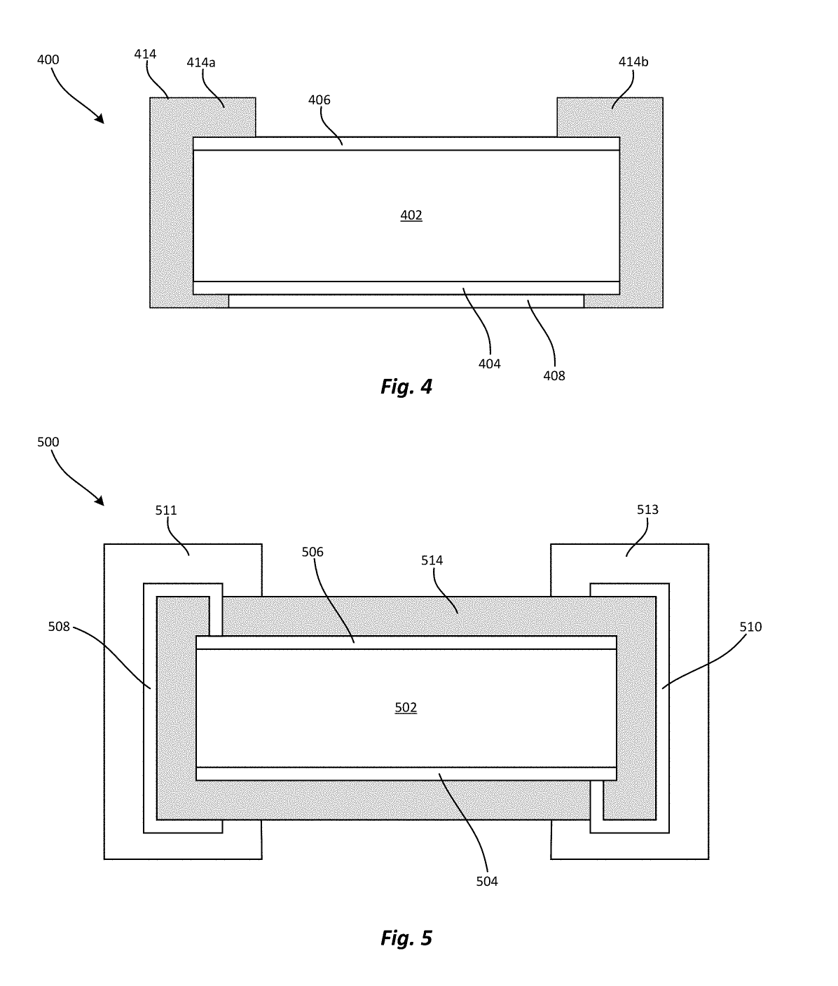

Referring to FIG. 4, a cross sectional view of a PTC device 400 in accordance with another exemplary embodiment of the present disclosure is illustrated. The PTC device 400 may include a core 402 formed of a PTC material. Various examples of PTC materials and their characteristics will be familiar to those of ordinary skill in the art and will therefore not be described in detail herein. In a non-limiting embodiment, the core 402 may be formed of a polymeric positive temperature coefficient (PPTC) material. The core 402 may be provided with first and second electrodes 404, 406 substantially covering bottom and top surfaces thereof, respectively.

The PTC device 400 may further include an electrically conductive lead element 408 that is electrically connected to the bottom surface of the core 402 via the first electrode 404 for facilitating connection of the PTC device 400 within a circuit. The lead element 408 may be substantially planar and may be disposed in flat and continuous contact with the first electrode 404. As depicted in FIG. 4, the lead element 408 may be narrower than the first electrode 404, but this is not critical. In various alternative embodiments, the lead element 408 may be wider than the first electrode 404. The lead element 408 may be formed of any suitable, electrically conductive material, including, but not limited to copper, silver, nickel, etc.

When the PTC device 100 is electrically connected within a circuit, the second electrode 406 and the lead element 408 may be used to connect the device to other circuit elements. Thus, electrical current flowing between the second electrode 406 and the lead element 408 must flow through the core 402, thus enabling the overcurrent and overtemperature protection provided by the device 400.

The PTC device 400 may further include an electrically insulating, protective encapsulant or package 414 (hereinafter “the package 414”). The package 414 may be a coating that covers portions of the other elements of the PTC device 400 in the manner shown in FIG. 4. Particularly, the package 414 may include first and second segments 414a, 414b that cover first and second opposing ends of the core 402, the first and second electrodes 404, 406, and the lead element 408, while leaving a portion of the top surface of the second electrode 406 and a portion of the bottom surface of the lead element 408 uncovered and exposed.

The package 414 of the device 400 may be formed of the oxygen barrier epoxy described above in relation to the PTC device 100, and may similarly provide the PTC device 400 with a robust, electrically insulating package that may be implemented using inexpensive and expeditious manufacturing techniques, such as transfer molding and the like, as will be described in greater detail below. The oxygen barrier properties of the package 414 may provide the components of the PTC device 400 with improved protection against corrosion relative to conventional PTC device packages. Additionally, the package 414 may have a coefficient of thermal expansion (CTE) that is substantially similar to the CTE of the core 402 of the PTC device 400, and may thus accommodate thermal expansion and contraction of the core 402 without the risk of damage.

Referring to FIG. 5, a cross sectional view of a PTC device 500 in accordance with another exemplary embodiment of the present disclosure is illustrated. The PTC device 500 may include a core 502 formed of a PTC material. Various examples of PTC materials and their characteristics will be familiar to those of ordinary skill in the art and will therefore not be described in detail herein. In a non-limiting embodiment, the core 502 may be formed of a polymeric positive temperature coefficient (PPTC) material. The core 502 may be provided with first and second electrodes 504, 506 substantially covering bottom and top surfaces thereof, respectively.

The PTC device 500 may further include electrically conductive first and second lead elements 508, 510 formed of conductive epoxy. The first lead element 508 may be disposed in contact with the first electrode 504 and may extend through, and around an exterior surface of, a first horizontal end of a package 514 (described below) that encapsulates the core 502. The second lead element 510 may be disposed in contact with the second electrode 506 and may extend through, and around an exterior surface of, a second horizontal end of the package 514 opposite the first horizontal end.

The first and second lead elements 508, 510 may be covered with first and second solderable coatings 511, 513 that, during installation of the PTC device 500, may be heated and reflowed for establishing electrical connections between the first and second lead element 508, 510 and other circuit elements, for example. The first and second solderable coatings 511, 513 may be formed of NiSn or NiAu, for example. Thus, when the PTC device 500 is electrically connected within a circuit, electrical current flowing between the first lead element 508 and the second lead element 510 must flow through the core 502, thus enabling the overcurrent and overtemperature protection provided by the device 500.

The PTC device 500 may further include an electrically insulating, protective encapsulant or package 514 (hereinafter “the package 514”). The package 514 may be a contiguous, unitary coating that covers and encapsulates the core 502 and portions of the first and second lead elements 508, 510 extending therefrom in the manner shown in FIG. 5. Portions of the first lead element 508 may be disposed on, and may extend around, bottom, side, and top surfaces of the first horizontal end of the package 514, and portions of the second lead element 510 may be disposed on, and may extend around, top, side, and bottom surfaces of the first horizontal end of the package 514.

The package 514 of the device 500 may be formed of the oxygen barrier epoxy described above in relation to the PTC device 500, and may similarly provide the PTC device 500 with a robust, electrically insulating package that may be implemented using inexpensive and expeditious manufacturing techniques, such as transfer molding and the like, as will be described in greater detail below. The oxygen barrier properties of the package 514 may provide the components of the PTC device 500 with improved protection against corrosion relative to conventional PTC device packages. Additionally, the package 514 may have a coefficient of thermal expansion (CTE) that is substantially similar to the CTE of the core 502 of the PTC device 500, and may thus accommodate thermal expansion and contraction of the core 502 without the risk of damage.

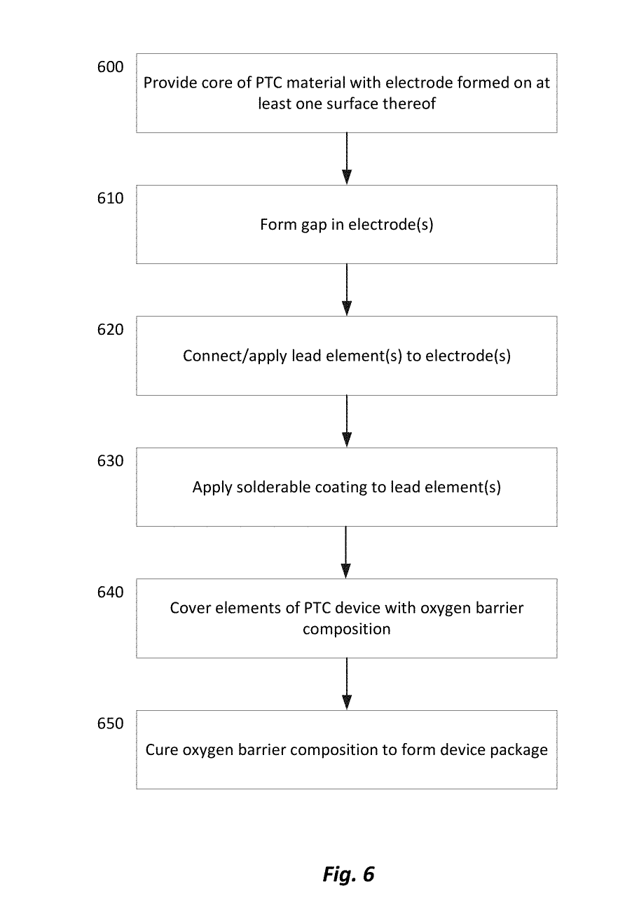

Referring to FIG. 6, a flow diagram illustrating an exemplary method for manufacturing the above-described PTC devices 100, 200, 300, 400, and 500, including packages associated with such devices, in accordance with the present disclosure is shown. The method will now be described in conjunction with the illustrations of the PTC devices 100, 200, 300, 400, and 500 shown in FIGS. 1-5.

At block 600 of the exemplary method, a core formed of a PTC material may be provided. Various examples of PTC materials and their characteristics will be familiar to those of ordinary skill in the art and will therefore not be described in detail herein. In a non-limiting embodiment, the core may be formed of a polymeric positive temperature coefficient (PPTC) material. The core may be provided with first and second electrodes substantially covering bottom and top surfaces thereof, respectively. In some embodiments, one of the first and second electrodes may be omitted.

At block 610 of the exemplary method, a gap may optionally be formed (e.g., etched, cut drilled, etc.) in one or both of the first and second electrodes to define two electrically isolated portions of electrically conductive foil on a single side of the core. For example, referring to the PTC device 200 shown in FIG. 2, a gap 205 may be formed in the first electrode 204 to define horizontally adjacent first and second portions 204a, 204b that are electrically isolated from one another except via the core 202. Alternatively, referring to the exemplary PTC device 300 shown in FIG. 3, both the first electrode 304 and the second electrode 306 may include respective gaps 305, 307 formed therein to define horizontally adjacent first and second portions 304a, 304b and 306a, 306b, respectively, that are electrically isolated from one another except via the core 302.

At block 620 of the exemplary method, one or more electrically conductive lead elements may be connected or applied to the core and/or the first and/or second electrodes, such as via solder reflow, conductive epoxy, eutectic bonding, wire bonding, etc. For example, referring to the device 100 shown in FIG. 1, the first lead element 108 formed of copper plate may be connected in flat and continuous contact with the first electrode 104, and second lead element 110 formed of copper plate may be electrically connected to the second electrode 106 by an interconnect 112 (e.g., via wire bonding). Referring to the exemplary PTC device 200 shown in FIG. 2, the first and second lead elements 208, 210 formed of copper plate may be electrically connected to the first and second portions 204a, 204b of the first electrode 204. Referring to the exemplary PTC device 300 shown in FIG. 3, the first lead element 308 formed of conductive epoxy may be applied over a first horizontal end of the core 302 and may cover the first portions 304a, 306a of the first and second electrodes 304, 306, respectively, and the second lead element 310 formed of conductive epoxy may be applied over a second horizontal end of the core 302 and may cover the second portions 304b, 306b of the first and second electrodes 304, 306, respectively. Referring to the exemplary PTC device 400 shown in FIG. 4, a single lead element 408 formed of copper plate may be connected in flat and continuous contact with the first electrode 404. Referring to the exemplary PTC device 500 shown in FIG. 5, the first lead element 508 formed of conductive epoxy may be applied in contact with the first electrode 504 and the second lead element 510 formed of conductive epoxy may be applied in contact with the second electrode 506.

At block 630 of the exemplary method, a solderable coating, such as may be formed of NiSn or NiAu, for example, may be applied to one or more of the lead elements. Thus, during installation of the PTC device, the solderable coating(s) may be heated and reflowed for establishing electrical connections between the first and/or second lead elements and other circuit elements. For example, referring to the exemplary PTC device 200 shown in FIG. 2, solderable coatings 211, 213 may be applied to the first and second lead elements 208, 210. Referring to the exemplary PTC device 300 shown in FIG. 3, first and second solderable coatings 311, 313 may be applied to the bottom portions of the first and second lead element 308, 310. Referring to the exemplary PTC device 500 shown in FIG. 5, the first and second solderable coatings 511, 513 may be applied to the first and second lead elements 508, 510.

At block 640 of the exemplary method, some or all of the elements of the PTC device that have been assembled thus far may be encapsulated in an oxygen barrier epoxy (e.g., the oxygen barrier epoxy described above). The epoxy may be applied to the elements of the PTC device using any of a variety of manufacturing processes that include, but are not limited to, stencil printing, molding (e.g., injection, transfer, compression, etc.), casting (e.g., dam and fill, underfill, etc.), and edge coating (pad print, ink set, etc.). For example, referring to the exemplary PTC device 100 shown in FIG. 1, the epoxy may be applied in a manner that completely covers and encapsulate the core 102, the first and second electrodes 104, 106, the first and second lead elements 108, 110, and the interconnect 112 except for the bottom surfaces of the first and second lead elements 108, 110 which are left uncovered and exposed. Referring to the exemplary PTC device 200 shown in FIG. 2, the epoxy may be applied in a manner that covers and encapsulate the core 202, the first and second electrodes 204, 206, and the first and second lead elements 208, 210, but not the first and second solderable coatings 211, 213 which are left uncovered and exposed. Referring to the exemplary PTC device 300 shown in FIG. 3, the epoxy may be applied in a manner that covers and encapsulates the core 302, the first and second electrodes 304, 306, and the first and second lead elements 308, 310, but not the first and second solderable coatings 311, 313 which are left uncovered and exposed. Referring to the exemplary PTC device 400 shown in FIG. 4, the epoxy may be applied in a manner that covers first and second opposing ends of the core 402, the first and second electrodes 404, 406, and the lead element 408, while leaving a portion of the top surface of the second electrode 406 and a portion of the bottom surface of the lead element 408 uncovered and exposed. Referring to the exemplary PTC device 500 shown in FIG. 5, the epoxy may be applied in a manner that covers and encapsulates the core 502 and portions of the first and second lead elements 508, 510 extending therefrom.

At block 650 of the exemplary method, the oxygen barrier epoxy, which was applied to some or all of the elements of the PTC device in a fluid or semi-fluid state (e.g., A-stage or B-stage), may be cured. The epoxy may be cured through a number of different methods. In one embodiment, the epoxy is fully cured (i.e., C-stage cured) in a single thermal stage. The operating temperature for fully curing the epoxy may vary based upon certain variables including the constituents of the epoxy (i.e., if there is an accelerator or not) and the time held at the elevated temperature. In certain embodiments, with or without an accelerator, a one-time full cure can be accomplished at a temperature of between approximately 150° C. and approximately 260° C. for about 1-6 hours.

Thus, the above-described method facilitates the manufacture of PTC devices having robust, electrically insulating device packages that are implemented in a cost effective, expeditious manner relative to conventional panelization processes that are relatively time-consuming, costly, and that require numerous complicated manufacturing steps. Moreover, PTC devices packages that are formed using the methods described herein may be implemented in a relatively small form factor compared to device packages that are manufactured using conventional panelization processes. This allows a larger core of PTC material to be implemented in a given device, thereby improving device capacity in a given form factor relative to devices that are packaged using conventional panelization processes.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A positive temperature coefficient (PTC) device comprising:
a core formed of a PTC material;
a first electrode disposed on a first surface of the core and a second electrode disposed on a second surface of the core;
a first lead element connected to the first electrode; and
an oxygen barrier package surrounding at least portions of the core, the first electrode, the second electrode, and the first lead element.

2. The PTC device of claim 1, wherein the oxygen barrier package is formed of an oxygen barrier epoxy.

3. The PTC device of claim 1, wherein portions of the first lead element and the second electrode are exposed for facilitating connections to other electrical components.

4. The PTC device of claim 1, wherein the first electrode comprises a first portion and a second portion separated by a gap, the first lead element connected to the first portion, the PTC device further comprising a second lead element connected to the second portion.

5. The PTC device of claim 4, further comprising a solderable coating disposed on at least one of the first and second lead elements.

6. The PTC device of claim 1, further comprising a second lead element connected to the second electrode, wherein portions of the first and second lead elements are exposed for facilitating connections to other electrical components.

7. The PTC device of claim 6, further comprising a solderable coating disposed on at least one of the first and second lead elements.

8. The PTC device of claim 6, wherein the first lead element is disposed on the first electrode, and the second lead element is disposed adjacent, and is coplanar with, the first lead element and is connected to the second electrode by an interconnect.

9. The PTC device of claim 6, wherein the first electrode includes a first portion and a second portion that are separated by a gap, the second electrode includes a first portion and a second portion that are separated by a gap, the first lead element is connected to the first portion of the first electrode and the first portion of the second electrode, and the second lead element is connected to the second portion of the first electrode and the second portion of the second electrode.

10. The PTC device of claim 6, wherein the first and second lead elements extend through the oxygen barrier package.

11. A method of forming a positive temperature coefficient (PTC) device, the method comprising:
providing a core formed of a PTC material, the core having a first electrode disposed on a first surface thereof and a second electrode disposed on a second surface thereof;
connecting a first lead element to the first electrode;
applying an oxygen barrier epoxy to at least portions of the core, the first electrode, the second electrode, and the first lead element; and
curing the oxygen barrier epoxy to form an oxygen barrier package surrounding at least portions of the core, the first electrode, the second electrode, and the first lead element.

12. The method of claim 11, wherein applying the oxygen barrier epoxy comprises molding the oxygen barrier epoxy over at least portions of the core, the first electrode, the second electrode, and the first lead element.

13. The method of claim 11, further comprising leaving portions of the first lead element and the second electrode exposed for facilitating connections to other electrical components.

14. The method of claim 11, wherein the first electrode comprises a first portion and a second portion separated by a gap, the first lead element connected to the first portion, the method further comprising connecting a second lead element to the second portion.

15. The method of claim 14, further comprising applying a solderable coating to at least one of the first and second lead elements.

16. The method of claim 11, further comprising connecting a second lead element to the second electrode and leaving portions of the first and second lead elements exposed for facilitating connections to other electrical components.

17. The method of claim 16, further comprising applying a solderable coating to at least one of the first and second lead elements.

18. The method of claim 16, further comprising disposing the first lead element on the first electrode, disposing the second lead element adjacent, and coplanar with, the first lead element, and connecting the second lead element to the second electrode with an interconnect.

19. The method of claim 16, wherein the first electrode includes a first portion and a second portion that are separated by a gap, and the second electrode includes a first portion and a second portion that are separated by a gap, the method further comprising connecting the first lead element to the first portion of the first electrode and to the first portion of the second electrode, and connecting the second lead element to the second portion of the first electrode and to the second portion of the second electrode.

20. The method of claim 16, wherein the first and second lead elements extend through the oxygen barrier package.
